(19) United States
(12) Patent Application Publication
(10) Pub. No.: US 2026/0281849 A1
(43) Pub. Date: Sep. 17, 2026

(54) SYSTEMS AND METHODS FOR RADIO RESOURCE CONTROL IDLE MODE/RADIO RESOURCE CONTROL INACTIVE MODE MOBILITY FROM TERRESTRIAL NETWORK-BASED ACCESS TO NON-TERRESTRIAL NETWORK-BASED ACCESS

(71) Applicant: APPLE INC., Cupertino, CA (US)

(72) Inventors: Fangli Xu, Beijing (CN); Yuqin Chen, Beijing (CN); Krishna Myneni, San Jose, CA (US); Sanjeevi Balasubramanian, San Jose, CA (US); Jie Cui, San Jose, CA (US); Haijing Hu, Los Gatos, CA (US); Dhruv Khati, San Jose, CA (US); Anjaneyulu Maganti, San Jose, CA (US)

(21) Appl. No.: 19/167,943

(22) PCT Filed: May 11, 2023
(86) PCT No.: PCT/CN2023/093635

§ 371 Date: Sep. 23, 2025

(51) Int. Cl. H04W 36/08; H04W 36/00; H04W 36/32; H04W 84/06

(52) U.S. Cl. CPC H04W 36/08; H04W 36/0058; H04W 36/0061; H04W 36/322; H04W 84/06

(57) ABSTRACT

Systems and methods for radio resource control (RRC) Idle mode/RRC Inactive mode mobility from terrestrial network (TN)-based access to non-terrestrial network (NTN)-based access are disclosed herein. A user equipment (UE) receives, from a network, on a terrestrial network (TN) cell, system information (SI) comprising cell reselection configuration information for an NTN neighbor cell that includes, among other things, a cell reselection condition for measuring the NTN neighbor cell. The UE then determines that the cell reselection condition for measuring the NTN neighbor cell is fulfilled and measures the NTN neighbor cell for purposes of a cell reselection in response. The cell reselection configuration information provided by the TN cell includes, among other things, NTN configuration information for the NTN neighbor cell (e.g., an epoch time, a validity duration for the cell reselection configuration information, ephemeris information, timing advance (TA) information, etc.) Examples of various cell reselection conditions are provided herein.

### TECHNICAL FIELD

This application relates generally to wireless communication systems, including wireless communications systems using NTN networks.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an NTN architecture of a wireless communication system, according to an embodiment.

FIG. 2 illustrates an NTN architecture of a wireless communication system, according to an embodiment.

FIG. 3 illustrates various avenues that may be contemplated/researched with respect to identifying potential NTN-TN and/or NTN-NTN mobility and service continuity enhancements within some wireless communication systems.

FIG. 4 illustrates a flow diagram for NTN-NTN RRC_IDLE/RRC_INACTIVE mobility, according to some embodiments.

FIG. 5A illustrates a listing of IEs that are present in a SIB 1 in some wireless communication systems.

FIG. 5B illustrates a definition for a cellBarredNTN IE as may be used in some wireless communication systems.

FIG. 6A illustrates a SIB 19 as may be used in some wireless communication systems.

FIG. 6B illustrates a definition for a referenceLocation IE as may be used in some wireless communication systems.

FIG. 6C illustrates a definition for a t-Service IE as may be used in some wireless communication systems.

FIG. 7A illustrates a SIB 19 700 that provides NTN configuration information as may be used in some wireless communication systems.

FIG. 7B illustrates an expanded view of an ntn-Config IE.

FIG. 7C illustrates an expanded view of the epochTime IE, illustrating the manner in which the epochTime IE carries an indication of an SFN and a subframe for an applicable epoch time, according to some wireless communication systems.

FIG. 7D illustrates a definition for an ntn-UlSyncValidityDuration IE as may be used in some wireless communication systems.

FIG. 7E illustrates a definition 718 for an epochTime IE as may be used in some wireless communication systems.

FIG. 7F illustrates an expanded view of a ta-Info IE, according to some wireless communication systems.

FIG. 8 include a diagram for a situation where a UE camps on an NTN cell only after it has otherwise determined that there is no available TN coverage, as occurs in some wireless communication systems.

FIG. 9 illustrates a flow diagram for TN-NTN RRC_IDLE/RRC_INACTIVE mobility, according to some embodiments.

FIG. 10A illustrates an InterFreqCarrierFreqInfo IE that may be used in a SIB 4 of some wireless communications systems.

FIG. 10B illustrates details of an ntn-NeighCellConfigList IE.

FIG. 11 illustrates a method of a UE, according to embodiments discussed herein.

FIG. 12 illustrates a method of a RAN, according to embodiments discussed herein.

FIG. 13 illustrates an example architecture of a wireless communication system, according to embodiments disclosed herein.

FIG. 14 illustrates a system for performing signaling between a wireless device and a RAN device connected to a core network of a CN device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Non-terrestrial networks (NTNs) refer to networks, or segments of networks, using an airborne or spaceborne vehicle for transmission (e.g., for operating one or more cells). These may include spaceborne vehicles such as low earth orbit (LEO) satellites, medium earth orbit (MEO) satellites, geostationary earth orbit (GEO) satellites, highly elliptical orbit (HEO) satellites, etc. and/or airborne vehicles/high altitude platforms (HAPS) such as airplanes, balloons, drones, etc.

Terrestrial network (TNs) refer to networks, or segments of networks, using terrestrial-based transmission points (e.g., for operating one or more cells).

NTN use may have particular utility in serving mobile broadband needs and public safety needs in areas and/or contexts that are unserved/underserved by TNs. Examples of such areas and/or contexts include maritime areas, airplane connectivity contexts, railway areas, etc.

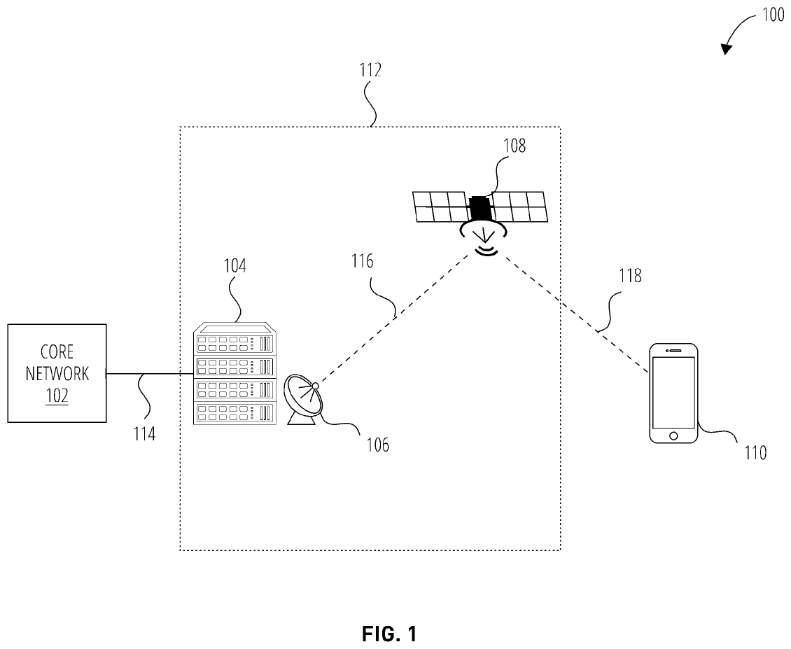

FIG. 1 illustrates an NTN architecture 100 of a wireless communication system, according to an embodiment. The NTN architecture 100 includes a core network (CN) 102, a terrestrial base station 104, a satellite gateway 106, a satellite 108, and a UE 110. The terrestrial base station 104, the satellite gateway 106, and the satellite 108 may be included in a RAN 112.

In some embodiments, the RAN 112 includes E-UTRAN, the CN 102 includes an EPC, and the terrestrial base station 104 includes an eNB. In these cases, the CN link 114 connecting the CN 102 and the terrestrial base station 104 may include an S1 interface.

In some embodiments, RAN 112 includes NG-RAN, the CN 102 includes a 5GC, and the terrestrial base station 104 includes a gNB or a next generation eNB (ng-eNB). In such cases, the CN link 114 connecting the CN 102 and the terrestrial base station 104 may include an NG interface.

The NTN architecture 100 illustrates a “bent-pipe” or “transparent” satellite based architecture. In such bent-pipe systems, the terrestrial base station 104 uses the satellite gateway 106 to communicate with the satellite 108 over a feeder link 116. The satellite 108 may be equipped with one or more antennas capable of broadcasting a cell according to the RAN 112, and the UE 110 may be equipped with one or more antennas (e.g., a moving parabolic antenna, an omni-directional phased-array antenna, etc.) capable of communicating with the satellite 108 via a Uu interface on that cell (such communications may be said to use the illustrated service link 118). A payload sited on the satellite 108 then transparently forwards data between the satellite gateway 106 and the UE 110 using the feeder link 116 between the satellite gateway 106 and the satellite 108 and the service link 118 between the satellite 108 and the UE 110. The payload may perform radio frequency (RF) conversion and/or amplification in both uplink (UL) and downlink (DL) to enable this communication.

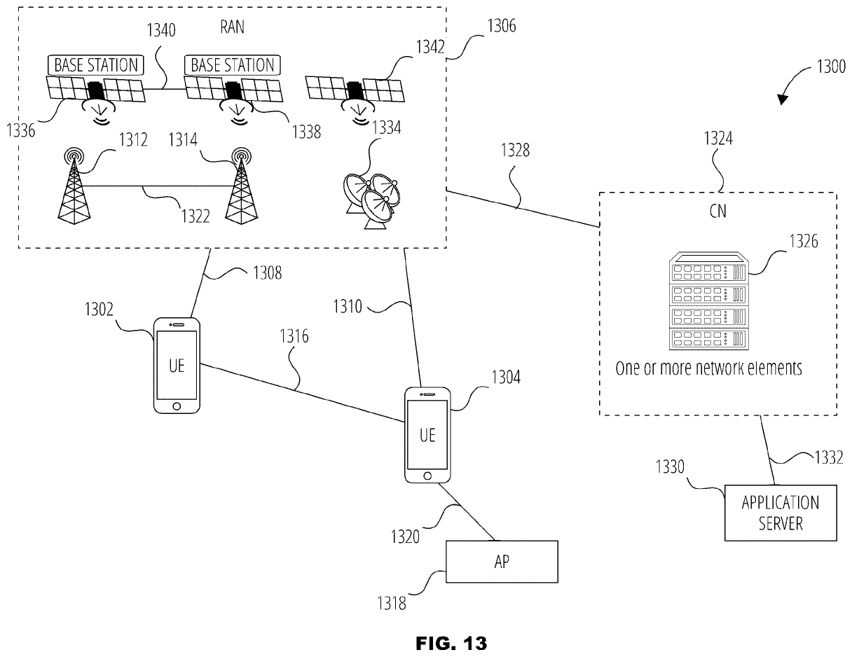

In the embodiment shown in FIG. 1, the terrestrial base station 104 is illustrated without the capability of terrestrial wireless communication directly with a UE. However, it is contemplated that in other embodiments, such a terrestrial base station using the satellite gateway 106 to communicate with the satellite 108 could (also) have this functionality (i.e., as in the terrestrial base station 1312 and the terrestrial base station 1314 of FIG. 13, to be described below).

It may be understood that, in alternative embodiments to FIG. 1, the satellite 108 may instead be a non-satellite NTN vehicle (e.g., an airplane, an unmanned aerial vehicle (UAV), an unmanned aircraft system (UAS), an airship, a balloon, etc.). Further, it may be understood in such alternative embodiments that the satellite gateway 106 may instead be a gateway for or corresponding to the applicable NTN vehicle type.

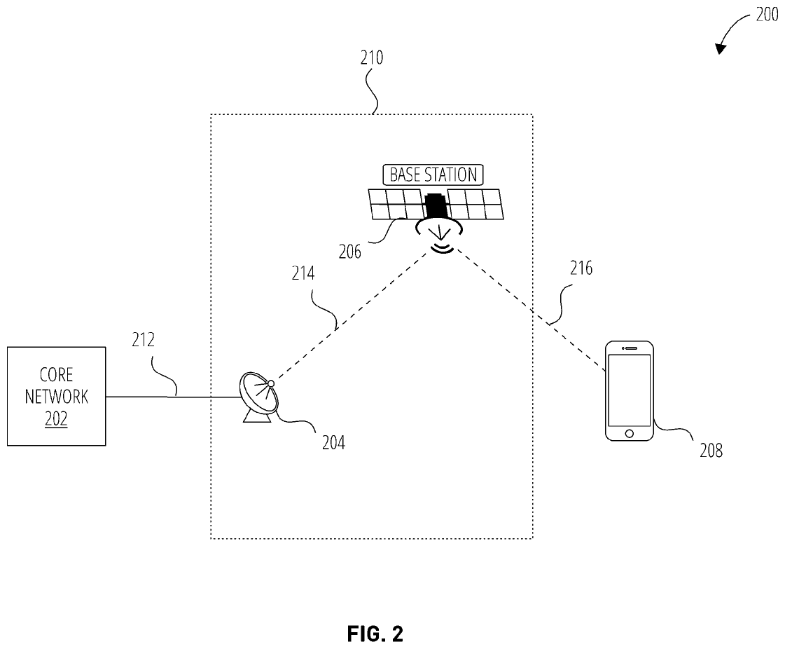

FIG. 2 illustrates an NTN architecture 200 of a wireless communication system, according to an embodiment. The NTN architecture 200 includes a CN 202, a satellite gateway 204, a satellite base station 206, and a UE 208. The satellite gateway 204 and the satellite base station 206 may be included in the RAN 210.

In some embodiments, the RAN 210 includes E-UTRAN and the CN 202 includes an EPC. In these cases, the CN link 212 connecting the CN 202 and the satellite gateway 204 may include an S1 interface.

In some embodiments, RAN 210 includes NG-RAN and the CN 202 includes a 5GC. In such cases, the CN link 212 connecting the CN 202 and the satellite gateway 204 may include an NG interface.

The NTN architecture 100 implements a “regenerative” satellite based architecture. In such regenerative systems, the functionalities of a base station are sited on the satellite base station 206, and the communications between these base station functions and the CN 202 occur through a forwarding of interface(s) (e.g., a S1 interface and/or an NG interface) found on the CN link 212 through the satellite gateway 204 and a feeder link 214 to the satellite base station 206. The satellite base station 206 may be equipped with one or more antennas capable of broadcasting a cell according to the RAN 210, and the UE 208 may be equipped with one or more antennas (e.g., a moving parabolic antenna, an omni-directional phased-array antenna, etc.) capable of communicating with the satellite base station 206 via a Uu interface on that cell (such communications may be said to use the illustrated service link 216). A payload sited on the satellite base station 206 then forwards data between the satellite gateway 204 and the UE 208 using the feeder link 214 between the satellite gateway 204 and the satellite base station 206 and the service link 216 between the satellite base station 206 and the UE 208. The payload may perform RF conversion and/or amplification in both UL and DL to enable this communication, as well as implement the functionalities of the base station (e.g., as an eNB, ng-eNB or a gNB, as corresponding to the type of the RAN 210) as these have been sited on the satellite base station 206.

In embodiments of NTN architectures comprising NG-RAN that also use integrated access and backhaul (IAB), it is possible that a gNB control unit functionality (CU) could be sited terrestrially and may use a satellite gateway to communicate with a satellite that hosts a corresponding gNB donor unit functionality (DU), with the F1 interface(s) between the CU and the DU underpinned by the feeder link 214. In such cases, the CU and the DU may each be understood to be part of the NG-RAN.

It may be understood that, in alternative embodiments to FIG. 2, the satellite base station 206 may instead be a non-satellite NTN base station (e.g., an airplane, a UAV, a UAS, an airship, a balloon, etc.). Further, it may be understood in such alternative embodiments that the satellite gateway 204 may instead be a gateway for or corresponding to the applicable NTN vehicle type.

In some wireless communication systems (e.g., NR wireless communication systems), embodiments for NTNs may contemplate the use of LEO and/or GEO satellites while also maintaining a compatibility to support HAPS and ATG (Air-To-Ground) scenarios. In such cases, there may be a focus on frequency division duplex (FDD) mechanisms (while time division duplex (TDD) mechanisms may remain usable for various relevant scenarios, such as, for example, HAPS and ATG). It may be in such cases that earth fixed tracking areas are used. Further, it may be in such cases that UEs are equipped with global navigation satellite system (GNSS) capabilities. It may be in such cases that a transparent payload is used across/through the non-terrestrial vehicle of the NTN. It may be in such cases that handheld devices in FR1 (e.g., power class 3 devices) are used, and/or that very small aperture terminal (VSAT) devices having an external antenna are used in FR2.

In some wireless communication systems, an NTN cell may be used to provide coverage using radio cells that are relatively wider, geographically speaking, than TN cells. In other words, with respect to NTN cells, the coverage of a cell or a beam may be larger than a coverage provided by a cell or a beam in TN cells. In some cases, the coverage of one NTN cell may be across multiple countries.

Note that as contemplated herein, a (single) RAN operating in a wireless communication system may incorporate both an NTN network segment that sources one or more NTN cells via one or more NTN vehicles and a TN network segment that sources one or more TN cells via one or more terrestrial-based transmission points. It is also noted that coverage areas between the one or more NTN cell(s) of the RAN and the one or more TN cell(s) of the RAN may overlap, either entirely or partially.

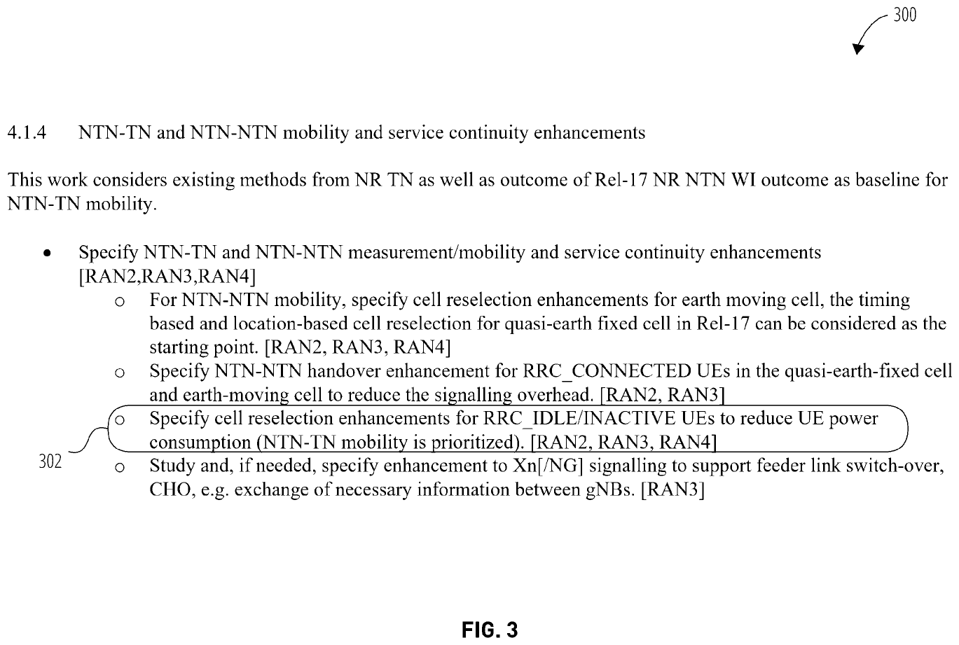

FIG. 3 illustrates various avenues 300 that may be contemplated/researched with respect to identifying potential NTN-to-TN (NTN-TN) and/or NTN-to-NTN (NTN-NTN) mobility and service continuity enhancements within some wireless communication systems. As illustrated in FIG. 3, it may be desirable to develop one or more enhancements 302 for cell reselection for UEs that are in one of a radio resource control (RRC) Idle (RRC_IDLE) mode or an RRC Inactive (RRC_INACTIVE) mode, such that UE power consumption is reduced/minimized.

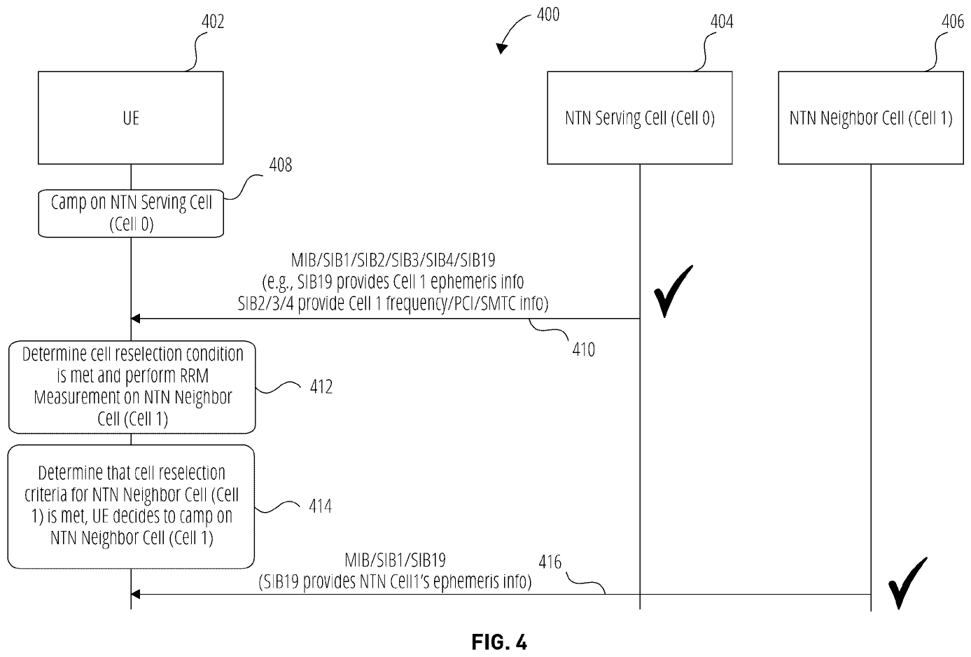

FIG. 4 illustrates a flow diagram 400 for NTN-NTN RRC_IDLE/RRC_INACTIVE mobility, according to some embodiments. The flow diagram 400 illustrates operations between a UE 402, an NTN serving cell 404, and an NTN neighbor cell 406 as may occur in some cases. The UE 402 may be understood to be in one of an RRC_IDLE mode and an RRC_INACTIVE mode.

Preliminarily, the UE 402 is camped 408 on the NTN serving cell 404. The NTN serving cell 404 provides 410 the UE 402 with cell reselection configuration information for the NTN neighbor cell 406. This cell reselection configuration information includes information about the NTN neighbor cell 406 that is used by the UE 402 to determine whether to perform a cell reselection to the NTN neighbor cell 406 from the NTN serving cell 404. For example, the cell reselection configuration information may include a cell reselection condition for measuring the NTN neighbor cell for cell reselection purposes. Further, the cell reselection configuration information may include/indicate an epoch time for the NTN neighbor cell 406, a validity duration for the cell reselection configuration information, a frequency of the NTN neighbor cell 406 (e.g., as identified by an absolute radio frequency channel number (ARFCN)), a physical cell identifier (PCI) of the NTN neighbor cell 406, synchronization signal block (SSB)-based radio resource management (RRM) measurement timing configuration (SMTC) information for the NTN neighbor cell 406, and/or ephemeris information for the NTN neighbor cell 406.

As illustrated in FIG. 3, the NTN serving cell 404 provides 410 the cell reselection configuration information to the UE as part of system information (SI) (e.g., using a master information block (MIB) and/or one or more system information blocks (SIBs)). As illustrated, it may be that, for example, a SIB 2, a SIB 3, and/or a SIB 4 provided to the UE 402 by the NTN serving cell 404 may comprise some items of cell reselection configuration information (including, for example, the frequency of the NTN neighbor cell 406, a PCI of the NTN neighbor cell 406, and/or an SMTC for the NTN neighbor cell 406), while a SIB 19 may provide other items of cell reselection configuration information (for example, ephemeris information for the NTN neighbor cell 406).

The UE 402 then determines 412 whether a cell reselection condition (e.g., an NTN-specific condition) for the UE to perform an RRM measurement in the NTN neighbor cell 406 has been met. If so, the UE proceeds to perform RRM measurement on the NTN neighbor cell 406.

Based on the measurement of the NTN neighbor cell 406, the UE determines 414 whether the NTN neighbor cell 406 meets cell reselection criteria for performing a cell reselection to the NTN neighbor cell 406. If the NTN neighbor cell 406 meets the cell reselection criteria, the UE proceeds to camp on the NTN neighbor cell 406.

As illustrated, the UE 402 may then proceed to receive 416 various items of system information (for example a MIB, a SIB 1, and/or a SIB 19) from the NTN neighbor cell 406.

In some wireless communication networks, a UE may determine an applicable network type (e. g, TN or NTN) implicitly based on the SI. For example, in some NR wireless communication systems, the UE may be informed of that an NTN network type applies through the existence of scheduling information for an SIB 19 in the SIB 1. In such cases, it may be that the ephemeris information of the SIB 19 may include satellite ephemeris of a serving cell and satellite ephemeris information of a neighbor cell.

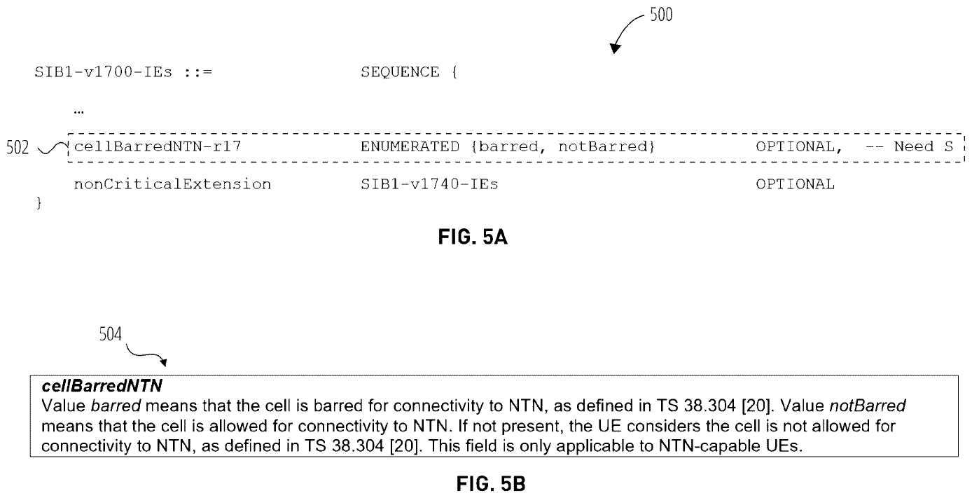

In some wireless communication systems, an NTN specific cell bar indication may be provided. FIG. 5A illustrates a listing 500 of information elements (IEs) that are present in a SIB 1 in some wireless communication systems. The listing 500 illustrates that a SIB 1 may include a cellBarredNTN-r17 IE 502. It may be that if the cellBarredNTN-r17 IE 502 is present in the SIB 1 as illustrated, an NTN UE considers the use of that NTN cell to be barred or allowed (depending on the indication made by the cellBarredNTN-r17 IE 502). In cases where the cellBarredNTN-r17 IE 502 is not present, an NTN UE may follow a legacy cellBarred behavior applicable for TN access and consider that the cell is not allowed for NTN access.

FIG. 5B illustrates a definition 504 for a cellBarredNTN IE (e.g., a cellBarredNTN-r17 IE) as may be used in some wireless communication systems.

Various aspects regarding the use of quasi-earth fixed cells are now discussed. A quasi-earth fixed cell may be a cell that is in a fixed in position relative to the surface of the earth as provided by a satellite that is moving relative to the surface of the earth. In such cases, the fixed position of the cell may be achieved through the use of beamforming by the satellite that compensates for the translation of the satellite relative to the surface of the earth. These cells may exist for only a limited time (due to, for example, the satellite moving out of position for providing the cell due to its relative motion with the earth's surface).

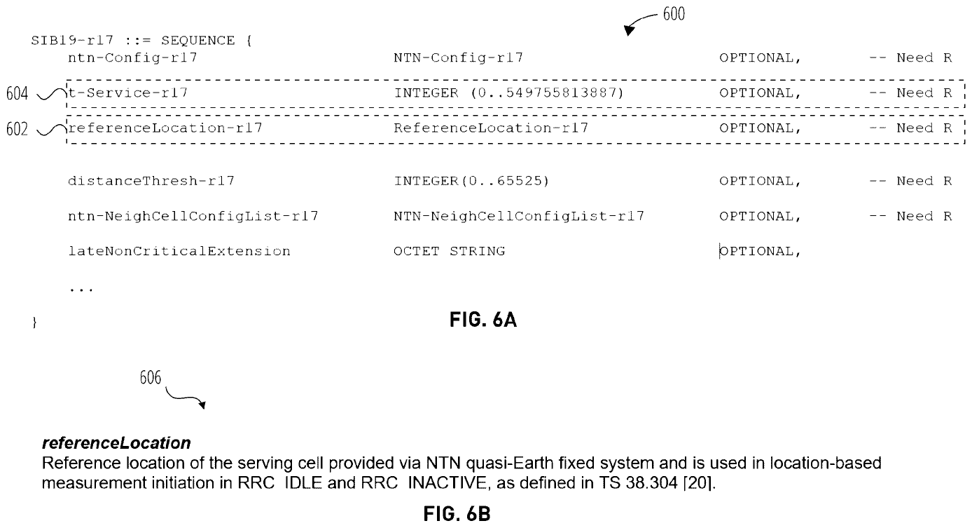

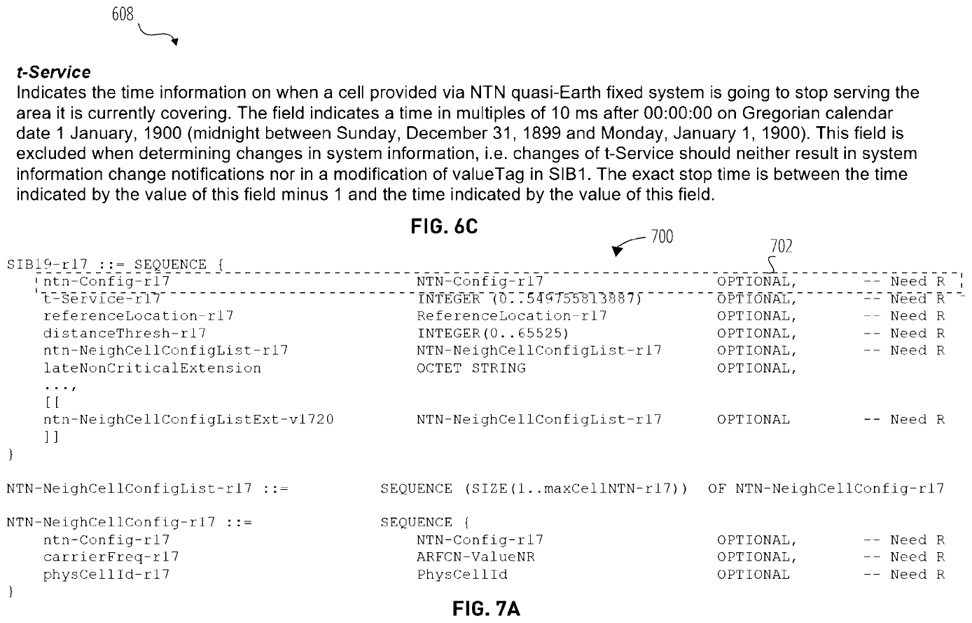

In some cases, location-based cell selection/reselection measurement mechanisms may be used in quasi-earth fixed cell scenarios. In such cases, location information may be provided to the UE in SI. FIG. 6A illustrates a SIB 19 600 (a SIB19-r17) as may be used in some wireless communication systems. The SIB 19 600 includes a referenceLocation IE 602 (a referenceLocation-r17 IE) that identifies a reference location of the serving cell. In location-based cell selection/reselection methods, it may be that if a distance between the UE and the reference location is greater than a maximum distance threshold, the UE may perform one or more of intra-frequency, inter-frequency, and/or inter-RAT measurements (as the case may be).

FIG. 6B illustrates a definition 606 for a referenceLocation IE (e.g., a referenceLocation-r17 IE) as may be used in some wireless communication systems.

In some cases, time-based cell selection/reselection measurement mechanisms may be used in quasi-earth fixed cell scenarios. In such cases, timing information may be provided to the UE in SI. For example, the SIB 19 600 includes a t-Service IE 604 (a t-Service-r17 IE) that indicates a stop time when the serving cell is going to stop serving a geographical area. In cases where this stop time for the serving cell is provided, then the UE may perform intra-frequency, inter-frequency or inter-RAT measurements prior to that stop time. The exact timing for the start of measurements prior to the stop time may be up to the UE implementation.

FIG. 6C illustrates a definition 608 for a t-Service IE (e.g., a t-Service-r17 IE) as may be used in some wireless communication systems.

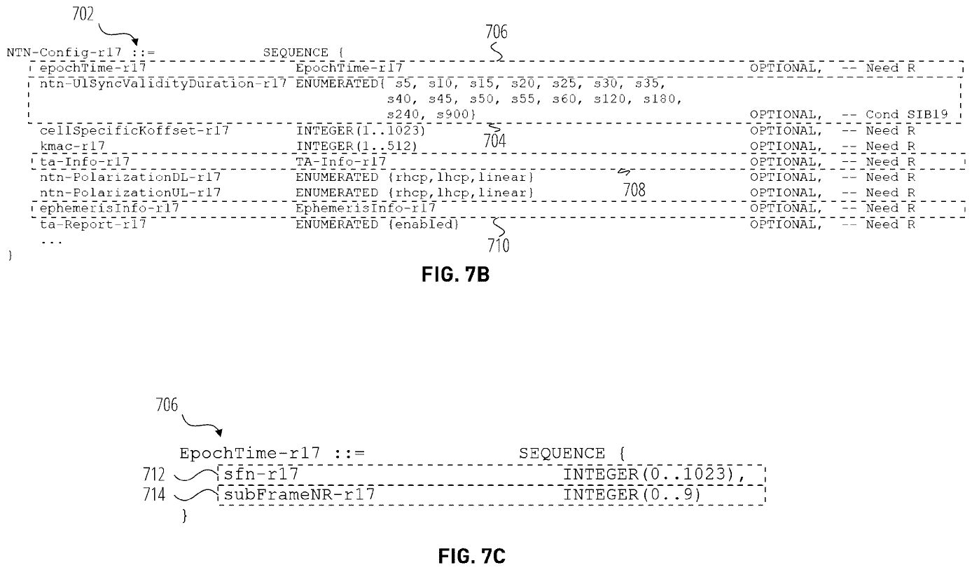

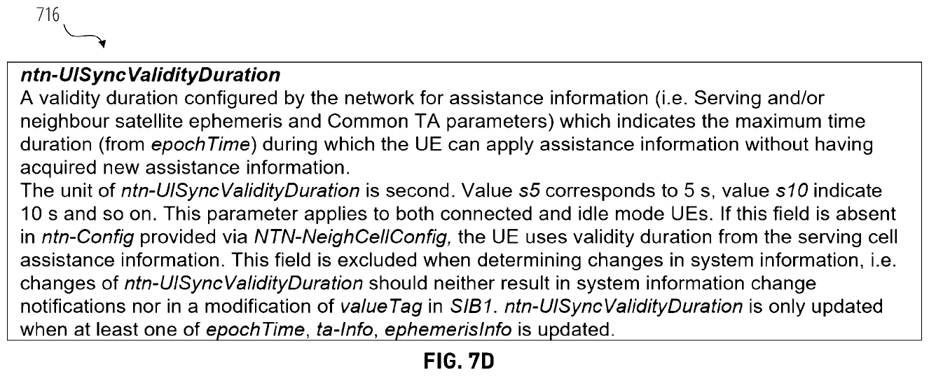

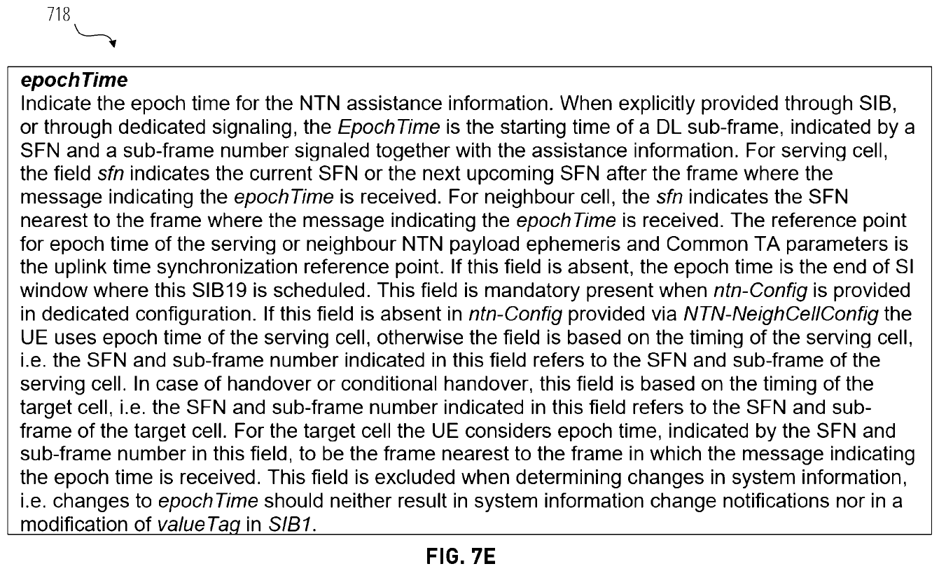

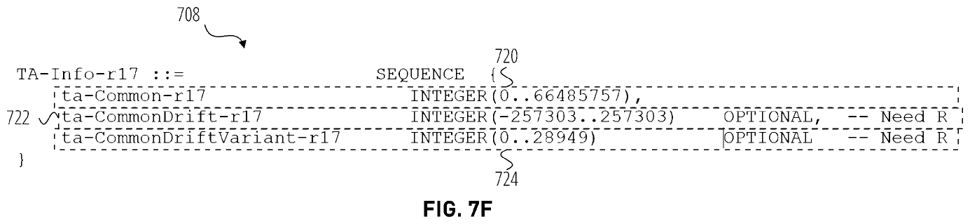

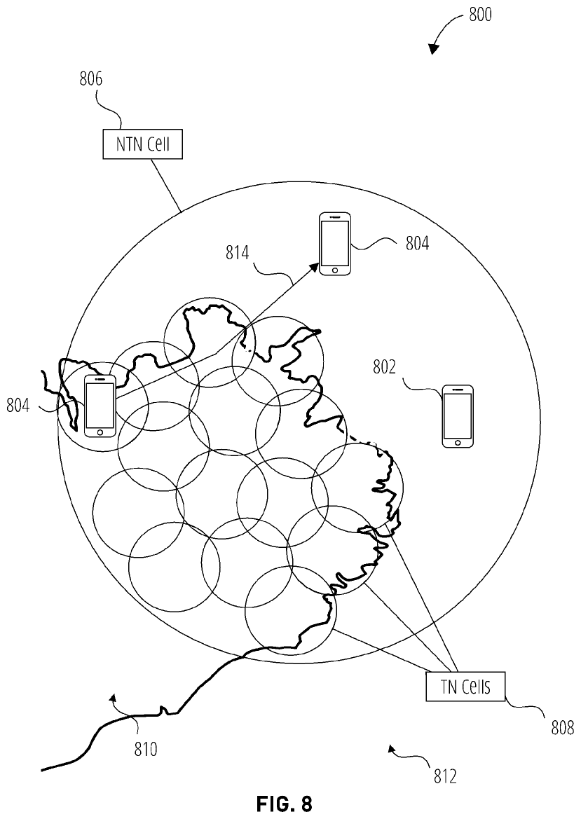

FIG. 7A illustrates a SIB 19 700 (a SIB19-r17) that provides NTN configuration information as may be used in some wireless communication systems. NTN configuration information provided in an SIB 19 700 may be understood to include NTN-specific configuration information that facilitates NTN access of an NTN cell by the UE.

Note that in some wireless communication systems, when a network provides NTN configuration information for an NTN neighbor cell (e.g., in a SIB 19), it is assumed that the network also provides NTN configuration information for the current serving cell.

As illustrated in FIG. 7A, the SIB 19 700 includes NTN configuration information for a cell (e.g., an NTN neighbor cell, a serving cell) an ntn-Config IE 702 (an ntn-Config-r17 IE). FIG. 7B illustrates an expanded view of the ntn-Config IE 702. The ntn-Config IE 702 may include uplink (UL) synchronization assistance information/NTN satellite assistance information for NTN access to the cell. One or more parameters for/used by a cell reselection condition may be provided in the ntn-Config IE 702. Other types of cell reselection configuration information (e.g., neighbor cell information for SMTC purposes) may be provided.

The ntn-Config IE 702 may include an ntn-UlSyncValidityDuration IE 704 that indicates a validity duration for which NTN satellite assistance information as provided in the ntn-Config IE 702 is valid. In cases where such a validity duration is not provided for a neighbor cell, the UE may assume the use of a validity duration for the serving cell. Upon receiving the ntn-UlSyncValidityDuration IE 704, the UE may start a timer for the corresponding validity duration. Note that in some circumstances, the UE is not strictly required to maintain a validity timer for the NTN neighbor cell.

The ntn-Config IE 702 may further include an epochTime IE 706 indicating an applicable epoch time associated with the validity of NTN satellite assistance information as understood with respect to a system frame number (SFN) and a subframe number. In some cases, the epoch time is determined based on the timing of the serving cell. In cases where an epoch time for a neighbor NTN cell is not provided, the UE may assume the use of an epoch time for the serving cell.

FIG. 7C illustrates an expanded view of the epochTime IE 706, illustrating the manner in which the epochTime IE 706 carries an indication of an SFN 712 and a subframe 714 for an applicable epoch time, according to some wireless communication systems.

FIG. 7D illustrates a definition 716 for an ntn-UlSyncValidityDuration IE (e.g., an ntn-UlSyncValidityDuration-r17 IE) as may be used in some wireless communication systems.

FIG. 7E illustrates a definition 718 for an epochTime IE (e.g., an epochTime-r17 IE) as may be used in some wireless communication systems.

NTN satellite assistance information included in the ntn-Config IE 702 may include information such as is found in, for example, a ta-Info IE 708 having network controlled/indicated timing advance (TA) information for the use of the cell (e.g., that takes into account the extended transmission distances for the applicable NTN case) and an ephemerisInfo IE 710 that provides ephemeris information for an NTN vehicle broadcasting the cell.

FIG. 7F illustrates an expanded view of the ta-Info IE 708, according to some wireless communication systems. The ta-Info IE 708 may include a ta-Common value 720 representing a network-controlled common TA value (e.g., any timing offset considered necessary by the network), a ta-CommonDrift value 722 indicating a drift rate for the ta-Common value 720, and a ta-CommonDriftVariant value 724 indicating a drift rate variation of the ta-Common value 720.

Particular handling may be used at the UE with respect to the use of an NTN validity duration. The NTN validity duration may be understood to apply to NTN satellite assistance information (e.g., serving satellite ephemeris and/or common TA parameters). The UE may start (or restart) a validity timer with the value indicated by the ntn-UlSyncValidityDuration IE 704, as measured from the subframe indicated by the epochTime IE 706. With respect to a current cell selection/reselection, the target cell's epoch time may be based on the target cell's timing.

The UE may apply any received NTN satellite assistance information during the NTN validity duration. The UE may further attempt to re-acquire an SIB 19 before any end of the NTN validity duration (e.g., per a UE implementation).

An SIB 19 may be provided by periodic broadcast. It may be that in some wireless communication systems, on-demand SIB 19 broadcast is not supported for UEs in any one or more of an RRC_IDLE, an RRC_INACTIVE, and/or an RRC connected (RRC_CONNECTED) state. Note that for a connected UE, the network may be able to provide the information of the SIB 19 to the UE via the dedicatedSystemInformationDelivery procedure with the UE.

Various wireless communication systems (e.g., some NR wireless communication systems) operate according to an effective restriction with respect to certain NTN mobility scenarios when a UE is in an RRC_IDLE and/or an RRC_INACTIVE state. For example, in such wireless communication systems, an RRM measurement for an NTN neighbor cell may be based on the cell reselection configuration information for the NTN neighbor cell as found in in SIB 2/SIB 3/SIB 4 and SIB 19. As discussed herein, in such cases, it may be that a SIB 2/SIB 3/SIB 4 provide, inter alia, a frequency/PCI/SMTC for the NTN neighbor measurement, while a SIB 19 provides NTN configuration information for the NTN neighbor cell.

However, in such wireless communication systems, it may be that at least some cell reselection configuration information (e.g., NTN configuration information as may be found in SIB 19) is only provided/broadcast in the serving cell when the serving cell is (also) an NTN cell, and may not be provided in the case that the serving cell is instead a TN cell. In the case where the serving cell is an TN cell, this may be problematic because, for example, without having access to satellite information for the NTN neighbor cell (e.g., without ephemeris information and/or a ta-Common value for the NTN neighbor cell), the UE is not capable of successfully/accurately performing an RRM measurement on the neighbor NTN cell (e.g., in order to determine whether to perform a cell reselection to the neighbor NTN cell).

This effectively causes a situation in such wireless communication systems where a UE can only camp on an NTN cell after it has otherwise determined that there is no available TN coverage. FIG. 8 include a diagram 800 for a situation where a UE camps on an NTN cell only after it has otherwise determined that there is no available TN coverage, as occurs in some wireless communication systems. The diagram 800 illustrates the first UE 802 (located in the ocean 812), the second UE 804 (which moves 814 from the landmass 810 to the ocean 812), an NTN cell 806, and various TN cells 808.

It may be that the first UE 802 camps on the NTN cell in the first instance (because the first UE 802 is located in the ocean 812 and not within range of any of the TN cells 808).

However, it may be that the second UE 804 is being served by one or more of the TN cells 808 while it is present on the landmass 810 (and thus within range of one or more of the TN cells 808). Then, as the UE moves 814 from landmass 810 to the ocean 812, to continue in network coverage, the UE needs to switch from the use of one or more of the TN cells 808 to the use of the NTN cell 806 as a serving cell (because the TN cells 808 are now out of range, as illustrated).

In such cases, the selection of the NTN cell 806 as the serving cell may occur only after the second UE 804 first makes a determination that it is out of coverage of the TN cells 808, and further identifies the NTN cell 806 after performing cell selection processes from an initial state.

Herein, mechanisms where a network of a wireless communication system provides cell reselection configuration information for an NTN neighbor cell to a UE via a TN cell are described. Such enhancements enable RRC_IDLE and/or RRC_INACTIVE mode UEs to perform cell reselection processes from a serving cell that is a TN cell to a target cell that is an NTN cell in a manner such that connectivity delays corresponding to such a TN-NTN transition are reduced/minimized. Such methods may be improvement over, e.g., methods where a UE first identifies that it is out of coverage of TN cells and then proceed to perform cell selection processes from an initial state to then identify an NTN cell (such as was discussed in relation to FIG. 8).

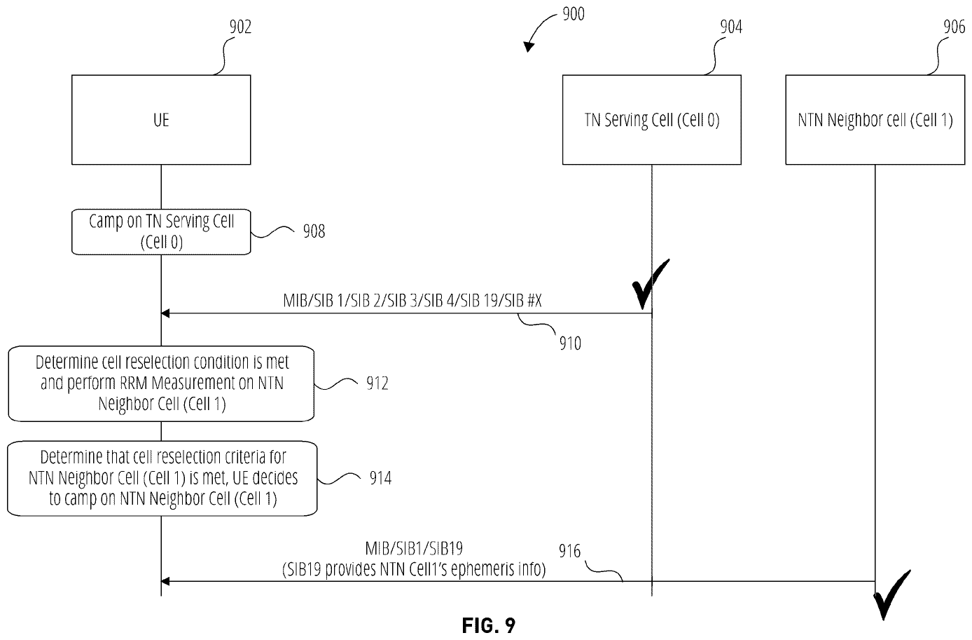

FIG. 9 illustrates a flow diagram 900 for TN-NTN RRC_IDLE/RRC_INACTIVE mobility, according to some embodiments. The flow diagram 900 illustrates operations between a UE 902, a TN serving cell 904, and an NTN neighbor cell 906 as may occur in some cases. The UE 902 may be understood to be in one of an RRC_IDLE mode and an RRC_INACTIVE mode.

Preliminarily, the UE 902 is camped 908 on the TN serving cell 904. The TN serving cell 904 provides 910 the UE 902 with cell reselection configuration information for the NTN neighbor cell 906. The cell reselection configuration information may include information about the NTN neighbor cell 906 that is used by the UE 902 to determine whether to perform a cell reselection to the NTN neighbor cell 906 from the TN serving cell 904. For example, the cell reselection configuration information may include a cell reselection condition for measuring the NTN neighbor cell for cell reselection purposes. The cell reselection configuration information may include/indicate a frequency of the NTN neighbor cell 906 (e.g., as identified by an ARFCN), a PCI of the NTN neighbor cell 906, SMTC information for the NTN neighbor cell 906. Further, the cell reselection configuration information may include NTN configuration information for the NTN neighbor cell 906, such as, for example, an epoch time for the NTN neighbor cell 906, a validity duration for the cell reselection configuration information, ephemeris information for the NTN neighbor cell 906, and/or TA information for the use of the NTN neighbor cell 906, etc.

It will be noted generally with respect to FIG. 9 that the TN serving cell 904 provides 910 the cell reselection configuration information to the UE as part of SI (e.g., using a MIB and/or one or more SIBs, as is discussed elsewhere herein in additional detail).

The UE 902 then determines 912 whether a cell reselection condition for the UE to perform an RRM measurement in the NTN neighbor cell 906 has been met. If so, the UE proceeds to perform RRM measurement on the NTN neighbor cell 906.

Based on the measurement of the NTN neighbor cell 906, the UE determines 914 whether the NTN neighbor cell 906 meets cell reselection criteria for performing the cell reselection to the NTN neighbor cell 906. If the NTN neighbor cell 906 meets the cell reselection criteria, the UE proceeds to camp on the NTN neighbor cell 906.

As illustrated, the UE 902 may then proceed to receive 916 various items of system information (for example a MIB, a SIB 1, and/or a SIB 19) from the NTN neighbor cell 906.

In embodiments corresponding to the flow diagram 900, it is contemplated that a cell reselection condition may be enhanced and/or different from cell reselection conditions used in NTN-NTN RRC_IDLE/RRC_INACTIVE mobility contexts, as described herein.

Note that in some embodiments, the network may also indicate to a UE a set of NTN neighbor cells (e.g., with respect to the present example, the network would indicate to the UE 902 that the NTN neighbor cell 906 is an NTN neighbor cell). In such cases where this information is provided, other neighbor cells not so indicated to the UE as NTN cells may be presumed by default at the UE to be TN cells.

In some embodiments, the UE determines that a cell is an NTN neighbor cell implicitly based on received SI. For example, in some NR wireless communication systems, the UE may be informed that an NTN network type applies for the NTN neighbor cell because of the existence of NTN configuration information for the NTN neighbor cell in received SI.

Various mechanisms for provisioning cell reselection configuration information for a NTN neighbor cell in a TN cell are now discussed.

In a first mechanism, the wireless communication system may support the use of a TN cell that uses an SIB 19 to provide NTN configuration information for the NTN neighbor cell and a SIB 2/a SIB 3/a SIB 4 to provide frequency/PCI/SMTC configuration information for the NTN neighbor cell. Thus, in cases according to this first mechanism, the UE may obtain cell reselection configuration information for a NTN neighbor cell from a SIB 2, at least one of a SIB 3 and a SIB 4, and a SIB 19. Note that in some such cases, it may be that only the neighbor cell's NTN configuration is included in the SIB 19.

In a second mechanism, a new SIB (a SIB X) may be used for NTN configuration information for the NTN neighbor cell. Thus, in cases according to the second mechanism, the UE may obtain cell reselection configuration information for a NTN neighbor cell from a SIB 2, at least one of a SIB 3 and a SIB 4, and a SIB X. Note that in cases according to this second mechanism, it may be that the SIB X contains information relevant only for the NTN neighbor cell reselection (e.g., only information about NTN neighboring cells).

In a third mechanism, NTN configuration information for the NTN neighbor cell may be added in a SIB 4 such that it appears along with frequency configuration information for the NTN neighbor cell that is present in the SIB 4. In some such cases, the SIB 4 may be understood to include frequency information for the TN serving cell and the NTN neighbor cell, wherein the NTN neighbor frequency information further itself includes the NTN configuration for the NTN neighbor cell.

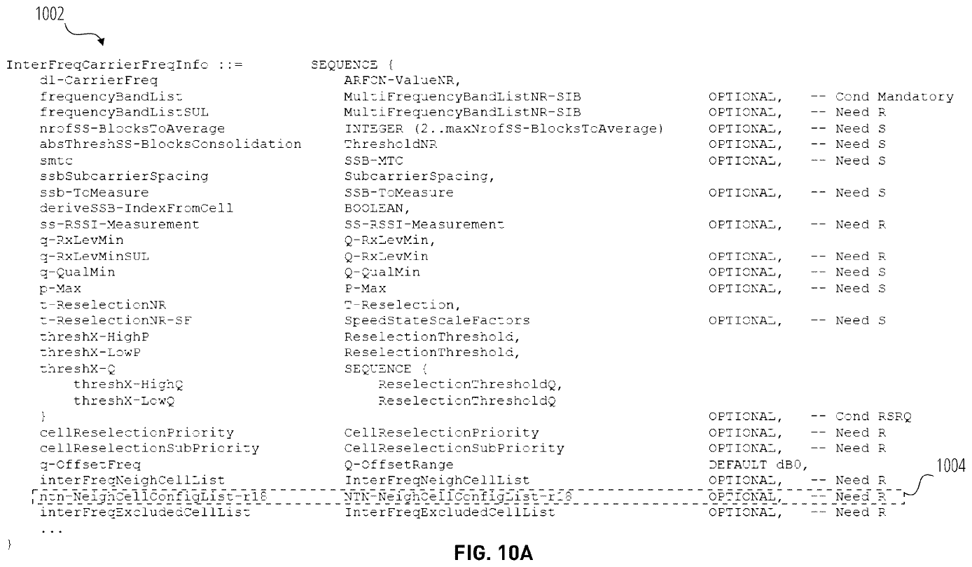

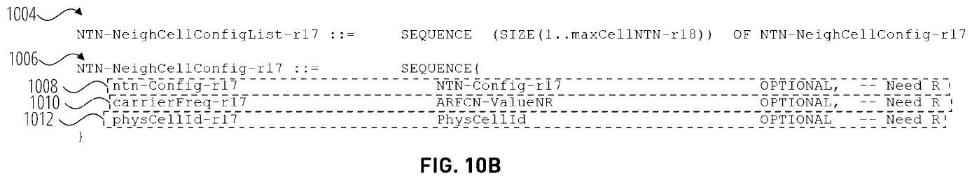

FIG. 10A illustrates an InterFreqCarrierFreqInfo IE 1002 that may be used in a SIB 4 of some wireless communications systems. The InterFreqCarrierFreqInfo IE 1002 includes an ntn-NeighCellConfigList IE 1004.

FIG. 10B illustrates details of the ntn-NeighCellConfigList IE 1004. As illustrated, the ntn-NeighCellConfigList IE 1004 may include one or more NTN-NeighCellConfig IEs 1006, which each NTN-NeighCellConfig IE 1006 corresponding to one NTN neighbor cell represented in the ntn-NeighCellConfigList IE 1004. Each NTN-NeighCellConfig IE 1006 may include an ntn-Config IE 1008 for its corresponding NTN neighbor cell, an indication of a carrierFreq value 1010 indicating (e.g., via an ARFCN) a frequency of its corresponding NTN neighbor cell, and a PhysCellId value 1012 providing a PCI of its corresponding NTN neighbor cell.

It is noted that if intra-frequency cell reselection from a TN cell to an NTN cell deployment is considered, analogous IEs to those shown in FIG. 10A and FIG. 10B but that are intended for inter-frequency contexts may be present in a SIB 3.

Accordingly, in cases according to the third mechanism, the UE may obtain cell reselection configuration information for a NTN neighbor cell from SIB 2 and at least one of a SIB 3 and a SIB 4.

In a fourth mechanism, a new SIB (a SIB Y) may be used for a full set of cell reselection configuration information for the NTN neighbor cell. In such cases, the SIB Y may contain information relevant only for the NTN neighbor cell reselection (e.g., information about NTN frequencies and NTN neighboring cells relevant for cell reselection). One or more IEs of the SIB Y may include cell reselection parameters that are common for a frequency. Thus, in cases according to the fourth mechanism, the UE may obtain cell reselection configuration information for a NTN neighbor cell from SIB Y.

It is noted that in the case that intra-frequency for the TN and NTN deployment is considered, a different new SIB (a SIB Z) having analogous information for intra-frequency NTN neighbor cells may be used (e.g., instead of a SIB Y).

Considerations with respect to NTN configuration information for a neighbor NTN cell as provided in a TN serving cell are now discussed.

It may be that NTN configuration information for one or more neighbor NTN cells as provided by a TN serving cell includes corresponding epoch time(s) for the NTN neighbor cell(s). In such cases, the epoch time provided for each of the NTN neighbor cells is determined based on the timing of the TN serving cell. In such cases, it may be that an epoch time is not allowed to be absent from the NTN configuration information for a neighbor NTN cell.

It may be that NTN configuration information for one or more neighbor NTN cells as provided by a TN serving cell includes corresponding validity duration(s) for NTN satellite assistance information for the NTN neighbor cell(s). In such cases, one of various alternatives may be implemented by the UE. In a first alternative, the UE maintains an individual validity timer for each of the neighbor NTN cells. Within a second alternative, the UE maintains only one validity timer that is based on one set of NTN configuration information for one NTN neighbor cell. The NTN neighbor cell so used may be determined according to a network configuration received at the UE.

Various cell reselection conditions for measuring the NTN neighbor cell as may be used in TN-NTN cell reselection contexts are now discussed.

In a first mechanism, a cell reselection condition for measuring the NTN neighbor cell may be based on radio quality. Under the first mechanism, the UE considers the cell reselection condition for measuring the NTN neighbor cell fulfilled when a radio quality of the TN serving cell is less than a threshold. The UE accordingly initiates a measurement on the NTN neighbor cell for purposes of cell reselection. Note that it is contemplated that applicable thresholds for the radio quality for initiating the measurement may be different for a TN neighbor cell and an NTN cell neighbor cell.

In a second mechanism, a cell reselection condition for measuring the NTN neighbor cell may be based on both radio quality and a delay timer. Under the second mechanism, the UE may start a delay timer of a delay timer duration when the radio quality of the TN serving cell is less than a threshold. The UE considers the cell reselection condition for measuring the NTN neighbor cell fulfilled when the delay timer expires without an intervening improvement of the radio quality of the TN serving cell back to at or above the threshold. The UE accordingly initiates a measurement on the NTN neighbor cell for purposes of cell reselection. Note that it is contemplated that applicable thresholds for the radio quality for initiating the measurement may be different for a TN neighbor cell and an NTN cell neighbor cell.

In a third mechanism, a cell reselection condition for measuring the NTN neighbor cell may be based on a location of the UE. It may be that the UE considers the cell reselection condition for measuring the NTN neighbor cell fulfilled when it determines that it is in a geographical area for using the NTN neighbor cell. Such a geographical area may be a particular geographical area that has been configured to the UE. The UE accordingly initiates a measurement on the NTN neighbor cell for purposes of cell reselection. Location information for such geographical area(s) may be provided from the network via broadcast signaling, in UE-dedicated RRC signaling, and/or by configuration from an application layer.

In one example with respect to FIG. 8, such a geographic area may be near the coastline of the landmass 810, and may be so set preparatory to the UE potentially going out onto the ocean 812 and out of range of the TN cells 808.

In a fourth mechanism, a cell reselection condition for measuring the NTN neighbor cell may be based on whether the UE is in TN coverage. It may be that the UE considers the cell reselection condition for measuring the NTN neighbor cell fulfilled if the UE cannot find an available TN cell. The UE accordingly initiates a measurement on the NTN neighbor cell for purposes of cell reselection.

Various options may be applied in the context of a UE determination that there is no available TN cell at the location of the UE. In a first option, the UE may make this determination after it cannot find any suitable NTN cells for at least a TN search duration. In a second option, the UE may make this determination after it fails to find any of a set of one or more preconfigured available TN cells identified in coverage information sent from the network to the UE.

In a fifth mechanism, the cell reselection condition for measuring the NTN neighbor cell may be based on a priority between a NTN cell/frequency and a TN cell/frequency. The network may configure the priority between the NTN cell/frequency and the TN cell/frequency for RRM measurement purposes. Accordingly, the UE may consider the cell reselection condition for measuring the neighbor NTN cell fulfilled when a priority for the NTN cell/frequency is higher than a priority for the TN cell/frequency (thus the UE measures the NTN cell prior for cell reselection purposes prior to measuring the TN cell for cell reselection purposes in such cases). It is noted that in some cases, for a neighbor NTN cell/frequency having a high priority, the UE may start the measurement of the NTN cell for cell reselection purposes even if a quality of a current serving cell is good.

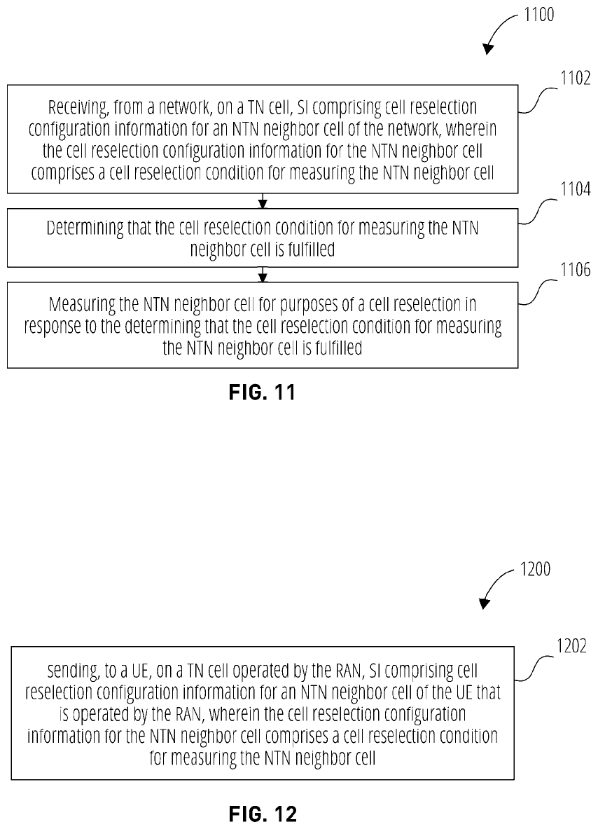

FIG. 11 illustrates a method 1100 of a UE, according to embodiments discussed herein. The method 1100 includes receiving 1102, from a network, on a TN cell, SI comprising cell reselection configuration information for an NTN neighbor cell of the network, wherein the cell reselection configuration information for the NTN neighbor cell comprises a cell reselection condition for measuring the NTN neighbor cell. The method 1100 further includes determining 1104 that the cell reselection condition for measuring the NTN neighbor cell is fulfilled. The method 1100 further includes measuring 1106 the NTN neighbor cell for purposes of a cell reselection in response to the determining that the cell reselection condition for measuring the NTN neighbor cell is fulfilled.

In some embodiments, the method 1100 further includes determining, based on the measuring of the NTN neighbor cell, that the NTN neighbor cell meets neighbor cell criteria for the cell reselection and performing the cell reselection to the neighbor NTN cell.

In some embodiments of the method 1100, the cell reselection configuration information for the NTN neighbor cell further comprises an epoch time for the NTN neighbor cell.

In some embodiments of the method 1100, the cell reselection configuration information for the NTN neighbor cell further comprises a validity duration for the cell reselection configuration information.

In some embodiments of the method 1100, the cell reselection configuration information for the NTN neighbor cell indicates a frequency of the NTN neighbor cell.

In some embodiments of the method 1100, the cell reselection configuration information for the NTN neighbor cell further comprises a PCI of the NTN neighbor cell.

In some embodiments of the method 1100, the cell reselection condition for measuring the NTN neighbor cell comprises that a radio quality of the TN cell is less than a threshold value. In some such embodiments, the cell reselection condition for measuring the NTN neighbor cell further comprises that the radio quality of the TN cell is less than the threshold value for a delay timer duration.

In some embodiments of the method 1100, the cell reselection condition for measuring the NTN neighbor cell comprises that the UE is located in a geographical area for using the NTN neighbor cell.

In some embodiments of the method 1100, the cell reselection condition for measuring the NTN neighbor cell comprises that there has been no available TN cell at a location of the UE for a TN search duration.

In some embodiments of the method 1100, the cell reselection condition for measuring the NTN neighbor cell comprises that there is no available preconfigured TN cell at a location of the UE.

In some embodiments of the method 1100, the cell reselection condition for measuring the NTN neighbor cell comprises that a first priority of the NTN neighbor cell is higher than a second priority of the TN cell.

In some embodiments of the method 1100, the SI comprising the cell reselection configuration information for the NTN neighbor cell is received in: a system information block (SIB) 2, one of a SIB 3 and a SIB 4, and a SIB 19; a SIB 2, one of a SIB 3 and a SIB 4, and a first SIB containing information that is relevant only for NTN neighbor cell reselection; a SIB 2 and one of a SIB 3 and a SIB 4; or only a second SIB containing information that is relevant for the NTN neighbor cell reselection.

FIG. 12 illustrates a method 1200 of a RAN, according to embodiments discussed herein. The method 1200 includes sending 1202, to a UE, on a TN cell operated by the RAN, SI comprising cell reselection configuration information for an NTN neighbor cell of the UE that is operated by the RAN, wherein the cell reselection configuration information for the NTN neighbor cell comprises a cell reselection condition for measuring the NTN neighbor cell.

In some embodiments of the method 1200, the cell reselection configuration information for the NTN neighbor cell further comprises an epoch time for the NTN neighbor cell.

In some embodiments of the method 1200, the cell reselection configuration information for the NTN neighbor cell further comprises a validity duration for the cell reselection configuration information.

In some embodiments of the method 1200, the cell reselection configuration information for the NTN neighbor cell indicates a frequency of the NTN neighbor cell.

In some embodiments of the method 1200, the cell reselection configuration information for the NTN neighbor cell further comprises a physical cell identifier (PCI) of the NTN neighbor cell.

In some embodiments of the method 1200, wherein the cell reselection condition for measuring the NTN neighbor cell comprises that a radio quality of the TN cell is less than a threshold value. In some such embodiments, the cell reselection condition for measuring the NTN neighbor cell further comprises that the radio quality of the TN cell is less than the threshold value for a delay timer duration.

In some embodiments of the method 1200, the cell reselection condition for measuring the NTN neighbor cell comprises that the UE is located in a geographical area for using the NTN neighbor cell.

In some embodiments of the method 1200, the cell reselection condition for measuring the NTN neighbor cell comprises that there has been no available TN cell at a location of the UE for a TN search duration.

In some embodiments of the method 1200, the cell reselection condition for measuring the NTN neighbor cell comprises that there is no available preconfigured TN cell at a location of the UE.

In some embodiments of the method 1200, the cell reselection condition for measuring the NTN neighbor cell comprises that a first priority of the NTN neighbor cell is higher than a second priority of the TN cell.

In some embodiments of the method 1200, the SI comprising the cell reselection configuration information for the NTN neighbor cell is sent in: a system information block (SIB) 2, one of a SIB 3 and a SIB 4, and a SIB 19; a SIB 2, one of a SIB 3 and a SIB 4, and a first SIB containing information that is relevant only for NTN neighbor cell reselection; a SIB 2 and one of a SIB 3 and a SIB 4; or only a second SIB containing information that is relevant for the NTN neighbor cell reselection.

FIG. 13 illustrates an example architecture of a wireless communication system 1300, according to embodiments disclosed herein. The following description is provided for an example wireless communication system 1300 that operates in conjunction with the LTE system standards and/or 5G or NR system standards as provided by 3GPP technical specifications and other 3GPP documents.

As shown by FIG. 13, the wireless communication system 1300 includes UE 1302 and UE 1304 (although any number of UEs may be used). In this example, the UE 1302 and the UE 1304 are illustrated as smartphones (e.g., handheld touchscreen mobile computing devices connectable to one or more cellular networks), but may also comprise any mobile or non-mobile computing device configured for wireless communication.

The UE 1302 and UE 1304 may be configured to communicatively couple with a RAN 1306. In embodiments, the RAN 1306 may be NG-RAN, E-UTRAN, etc. The UE 1302 and UE 1304 utilize connections (or channels) (shown as connection 1308 and connection 1310, respectively) with the RAN 1306, each of which comprises a physical communications interface. The RAN 1306 can include one or more base stations (such as terrestrial base station 1312, the terrestrial base station 1314 the satellite base station 1336 and the satellite base station 1338) and/or other entities (e.g., the satellite 1342, which may not have base station functionality) that enable the connection 1308 and connection 1310. One or more satellite gateways 1334 may integrate the satellite base station 1336, satellite base station 1338, and/or the satellite 1342 into the RAN 1306, in the manners (and with the appropriate elements) described in relation to the NTN architecture 100 of FIG. 1 and the NTN architecture 200 of FIG. 2.

It may be understood that, in alternative embodiments to FIG. 13, the satellite base station 1336, the satellite base station 1338, and/or the satellite 1342 may instead comprise a non-satellite NTN vehicle (e.g., an airplane, a UAV, a UAS, an airship, a balloon, etc.). Further, it may be understood in such alternative embodiments that any satellite gateway 1334 may be a gateway for or corresponding to that applicable NTN vehicle type.

In this example, the connection 1308 and connection 1310 are air interfaces to enable such communicative coupling, and may be consistent with RAT(s) used by the RAN 1306, such as, for example, an LTE and/or NR. It is contemplated that the connection 1308 and connection 1310 may include, in some embodiments, service links between their respective UE 1302, UE 1304 and one or more of the satellite base station 1336, the satellite base station 1338, and the satellite 1342.

In some embodiments, the UE 1302 and UE 1304 may also directly exchange communication data via a sidelink interface 1316.

The UE 1304 is shown to be configured to access an access point (shown as AP 1318) via connection 1320. By way of example, the connection 1320 can comprise a local wireless connection, such as a connection consistent with any IEEE 802.11 protocol, wherein the AP 1318 may comprise a Wi-Fi® router. In this example, the AP 1318 may be connected to another network (for example, the Internet) without going through a CN 1324.

In embodiments, the UE 1302 and UE 1304 can be configured to communicate using orthogonal frequency division multiplexing (OFDM) communication signals with each other, with the terrestrial base station 1312, the terrestrial base station 1314, the satellite base station 1336, the satellite base station 1338, and/or the satellite 1342 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the terrestrial base station 1312, terrestrial base station 1314, the satellite base station 1336 and/or the satellite base station 1338 may be implemented as one or more software entities running on server computers as part of a virtual network.

In addition, or in other embodiments, the terrestrial base station 1312 or terrestrial base station 1314 may be configured to communicate with one another via interface 1322. In embodiments where the wireless communication system 1300 is an LTE system (e.g., when the CN 1324 is an EPC), the interface 1322 may be an X2 interface. The X2 interface may be defined between two or more base stations (e.g., two or more eNBs and the like) that connect to an EPC, and/or between two eNBs connecting to the EPC. It is contemplated than an inter-satellite link (ISL) may carry the X2 interface between in the case of two satellite base stations.

In embodiments where the wireless communication system 1300 is an NR system (e.g., when CN 1324 is a 5GC), the interface 1322 may be an Xn interface. An Xn interface is defined between two or more base stations that connect to 5GC (e.g., CN 1324). For example, the Xn interface may be between two or more gNBs that connect to 5GC, a gNB connecting to 5GC and an eNB, between two eNBs connecting to 5GC, and/or two or more satellite base stations via an ISL (as in, e.g., the interface 1340 between the satellite base station 1336 and the satellite base station 1338).

The RAN 1306 is shown to be communicatively coupled to the CN 1324. The CN 1324 may comprise one or more network elements 1326, which are configured to offer various data and telecommunications services to customers/subscribers (e.g., users of UE 1302 and UE 1304) who are connected to the CN 1324 via the RAN 1306. The components of the CN 1324 may be implemented in one physical device or separate physical devices including components to read and execute instructions from a machine-readable or computer-readable medium (e.g., a non-transitory machine-readable storage medium). For example, the components of the CN 1324 may be implemented in one or more processors and/or one or more associated memories.

In embodiments, the CN 1324 may be an EPC, and the RAN 1306 may be connected with the CN 1324 via an S1 interface 1328. In embodiments, the SI interface 1328 may be split into two parts, an S1 user plane (S1-U) interface, which carries traffic data between the terrestrial base station 1312, terrestrial base station 1314, the satellite base station 1336, or the interface 1340 and a serving gateway (S-GW), and the S1-MME interface, which is a signaling interface between the terrestrial base station 1312, the terrestrial base station 1314 the satellite base station 1336, or the interface 1340 and mobility management entities (MMEs).

In embodiments, the CN 1324 may be a 5GC, and the RAN 1306 may be connected with the CN 1324 via an NG interface 1328. In embodiments, the NG interface 1328 may be split into two parts, an NG user plane (NG-U) interface, which carries traffic data between the terrestrial base station 1312, terrestrial base station 1314, satellite base station 1336, or satellite base station 1338 and a user plane function (UPF), and the S1 control plane (NG-C) interface, which is a signaling interface between the terrestrial base station 1312, terrestrial base station 1314 satellite base station 1336, or satellite base station 1338 and access and mobility management functions (AMFs).

Generally, an application server 1330 may be an element offering applications that use internet protocol (IP) bearer resources with the CN 1324 (e.g., packet switched data services). The application server 1330 can also be configured to support one or more communication services (e.g., VoIP sessions, group communication sessions, etc.) for the UE 1302 and UE 1304 via the CN 1324. The application server 1330 may communicate with the CN 1324 through an IP communications interface 1332.

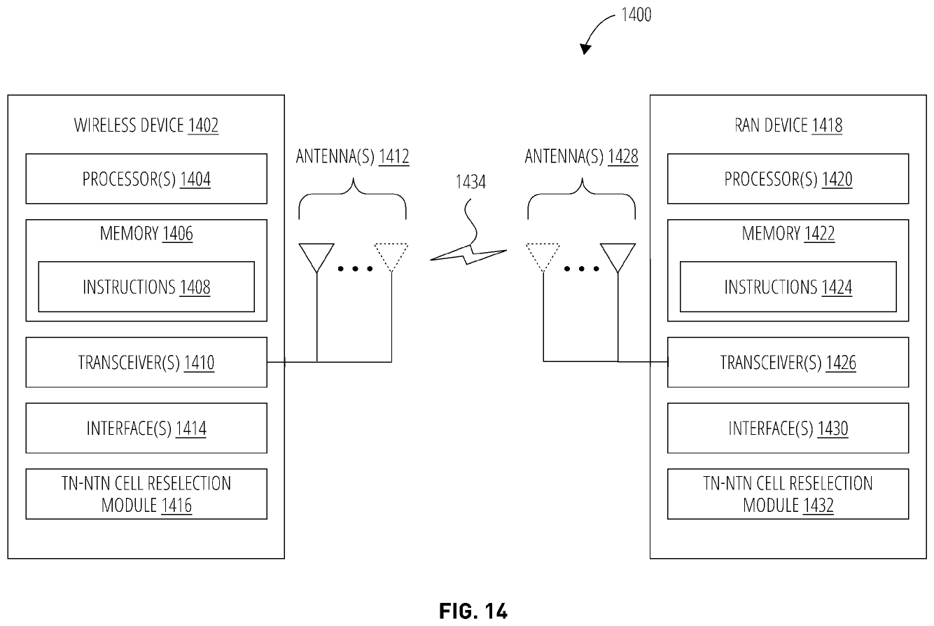

FIG. 14 illustrates a system 1400 for performing signaling 1434 between a wireless device 1402 and a RAN device 1418, according to embodiments disclosed herein. The system 1400 may be a portion of a wireless communications system as herein described. The wireless device 1402 may be, for example, a UE of a wireless communication system. The RAN device 1418 may be, for example, a base station (e.g., an eNB or a gNB) of a wireless communication system that is a terrestrial base station or that is a non-terrestrial base station sited on an NTN vehicle. In the case of a RAN device 1418 that is a terrestrial base station, the RAN device 1418 may be in communication with an NTN vehicle that directly provides radio access connectivity to a UE, in the manner described herein.

The wireless device 1402 may include one or more processor(s) 1404. The processor(s) 1404 may execute instructions such that various operations of the wireless device 1402 are performed, as described herein. The processor(s) 1404 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1402 may include a memory 1406. The memory 1406 may be a non-transitory computer-readable storage medium that stores instructions 1408 (which may include, for example, the instructions being executed by the processor(s) 1404). The instructions 1408 may also be referred to as program code or a computer program. The memory 1406 may also store data used by, and results computed by, the processor(s) 1404.

The wireless device 1402 may include one or more transceiver(s) 1410 that may include RF transmitter and/or receiver circuitry that use the antenna(s) 1412 of the wireless device 1402 to facilitate signaling (e.g., the signaling 1434) to and/or from the wireless device 1402 with other devices (e.g., the RAN device 1418) according to corresponding RATs. In some embodiments, the antenna(s) 1412 may include a moving parabolic antenna, an omni-directional phased-array antenna, or some other antenna suitable for communication with an NTN vehicle, (e.g., as described above in relation to the UE 110 of FIG. 1 and the UE 208 of FIG. 2).

For a RAN device 1418 that is a terrestrial base station, the network device signaling 1434 may occur on a service link between the wireless device 1402 and an NTN vehicle and a feeder link between the NTN vehicle and the RAN device 1418 (e.g., as described in relation to FIG. 1). For a RAN device 1418 that is a base station sited on an NTN vehicle, the signaling 1434 may occur on a service link between the wireless device 1402 and the RAN device 1418 (e.g., as described in relation to FIG. 2).

The wireless device 1402 may include one or more antenna(s) 1412 (e.g., one, two, four, or more). For embodiments with multiple antenna(s) 1412, the wireless device 1402 may leverage the spatial diversity of such multiple antenna(s) 1412 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1402 may be accomplished according to precoding (or digital beamforming) that is applied at the wireless device 1402 that multiplexes the data streams across the antenna(s) 1412 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1402 may implement analog beamforming techniques, whereby phases of the signals sent by the antenna(s) 1412 are relatively adjusted such that the (joint) transmission of the antenna(s) 1412 can be directed (this is sometimes referred to as beam steering).

The wireless device 1402 may include one or more interface(s) 1414. The interface(s) 1414 may be used to provide input to or output from the wireless device 1402. For example, a wireless device 1402 that is a UE may include interface(s) 1414 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 1410/antenna(s) 1412 already described) that allow for communication between the UE and other devices and may operate according to known protocols (e.g., Wi-Fi®, Bluetooth®, and the like).

The wireless device 1402 may include a TN-NTN cell reselection module 1416. The TN-NTN cell reselection module 1416 may be implemented via hardware, software, or combinations thereof. For example, the TN-NTN cell reselection module 1416 may be implemented as a processor, circuit, and/or instructions 1408 stored in the memory 1406 and executed by the processor(s) 1404. In some examples, the TN-NTN cell reselection module 1416 may be integrated within the processor(s) 1404 and/or the transceiver(s) 1410. For example, the TN-NTN cell reselection module 1416 may be implemented by a combination of software components (e.g., executed by a DSP or a general processor) and hardware components (e.g., logic gates and circuitry) within the processor(s) 1404 or the transceiver(s) 1410.

The TN-NTN cell reselection module 1416 may be used for various aspects of the present disclosure, for example, aspects of FIG. 1 through FIG. 10B. The TN-NTN cell reselection module 1416 may be configured to, for example, receiving, on a TN cell, SI comprising cell reselection configuration information for a NTN neighbor cell, identify a cell reselection condition for measuring the NTN neighbor cell, determine that the cell reselection condition for measuring the NTN neighbor cell is fulfilled, and/or measure the NTN neighbor cell for purposes of a cell reselection in response to the determining that the cell reselection condition for measuring the NTN neighbor cell is fulfilled, in the manner described herein.

The RAN device 1418 may include one or more processor(s) 1420. The processor(s) 1420 may execute instructions such that various operations of the RAN device 1418 are performed, as described herein. The processor(s) 1404 may include one or more baseband processors implemented using, for example, a CPU, a DSP, an ASIC, a controller, an FPGA device, another hardware device, a firmware device, or any combination thereof configured to perform the operations described herein.

The RAN device 1418 may include a memory 1422. The memory 1422 may be a non-transitory computer-readable storage medium that stores instructions 1424 (which may include, for example, the instructions being executed by the processor(s) 1420). The instructions 1424 may also be referred to as program code or a computer program. The memory 1422 may also store data used by, and results computed by, the processor(s) 1420.

The RAN device 1418 may include one or more transceiver(s) 1426 that may include RF transmitter and/or receiver circuitry that use the antenna(s) 1428 of the RAN device 1418 to facilitate signaling (e.g., the signaling 1434) to and/or from the RAN device 1418 with other devices (e.g., the wireless device 1402) according to corresponding RATs.

The RAN device 1418 may include one or more antenna(s) 1428 (e.g., one, two, four, or more). In embodiments having multiple antenna(s) 1428, the RAN device 1418 may perform MIMO, digital beamforming, analog beamforming, beam steering, etc., as has been described.

For a RAN device 1418 that is a terrestrial base station, one or more of the transceiver(s) 1426 and/or the antenna(s) 1428 may instead be present on a satellite gateway (or a gateway for another applicable NTN vehicle type) associated with the base station (e.g., as shown in reference to the terrestrial base station 104 and the satellite gateway 106 of FIG. 1). For a RAN device 1418 that is a base station sited on an NTN vehicle, the transceiver(s) 1426 and/or the antenna(s) 1428 may be present on the NTN vehicle, and one or more of those antenna(s) 1428 may be antenna(s) appropriate for non-terrestrial communication (such as a moving parabolic antenna, an omni-directional phased-array antenna, etc.)

The RAN device 1418 may include one or more interface(s) 1430. The interface(s) 1430 may be used to provide input to or output from the RAN device 1418. For example, a RAN device 1418 that is a base station may include interface(s) 1430 made up of transmitters, receivers, and other circuitry (e.g., other than the transceiver(s) 1426/antenna(s) 1428 already described) that enables the base station to communicate with other equipment in a CN, and/or that enables the base station to communicate with external networks, computers, databases, and the like for purposes of operations, administration, and maintenance of the base station or other equipment operably connected thereto.

The RAN device 1418 may include a TN-NTN cell reselection module 1432. The TN-NTN cell reselection module 1432 may be implemented via hardware, software, or combinations thereof. For example, the TN-NTN cell reselection module 1432 may be implemented as a processor, circuit, and/or instructions 1424 stored in the memory 1422 and executed by the processor(s) 1420. In some examples, the TN-NTN cell reselection module 1432 may be integrated within the processor(s) 1420 and/or the transceiver(s) 1426. For example, the TN-NTN cell reselection module 1432 may be implemented by a combination of software components (e.g., executed by a DSP or a general processor) and hardware components (e.g., logic gates and circuitry) within the processor(s) 1420 or the transceiver(s) 1426.

The TN-NTN cell reselection module 1432 may be used for various aspects of the present disclosure, for example, aspects of FIG. 1 through FIG. 10B. The TN-NTN cell reselection module 1432 is configured to, for example, send, to a UE, on a TN cell, SI comprising cell reselection configuration information for a NTN neighbor cell of the UE that is operated by the RAN, in the manner that is described herein.

Embodiments contemplated herein include an apparatus comprising means to perform one or more elements of the method 1100. This apparatus may be, for example, an apparatus of a UE (such as a wireless device 1402 that is a UE, as described herein).

Embodiments contemplated herein include one or more non-transitory computer-readable media comprising instructions to cause an electronic device, upon execution of the instructions by one or more processors of the electronic device, to perform one or more elements of the method 1100. This non-transitory computer-readable media may be, for example, a memory of a UE (such as a memory 1406 of a wireless device 1402 that is a UE, as described herein).

Embodiments contemplated herein include an apparatus comprising logic, modules, or circuitry to perform one or more elements of the method 1100. This apparatus may be, for example, an apparatus of a UE (such as a wireless device 1402 that is a UE, as described herein).

Embodiments contemplated herein include an apparatus comprising: one or more processors and one or more computer-readable media comprising instructions that, when executed by the one or more processors, cause the one or more processors to perform one or more elements of the method 1100. This apparatus may be, for example, an apparatus of a UE (such as a wireless device 1402 that is a UE, as described herein).

Embodiments contemplated herein include a signal as described in or related to one or more elements of the method 1100.

Embodiments contemplated herein include a computer program or computer program product comprising instructions, wherein execution of the program by a processor is to cause the processor to carry out one or more elements of the method 1100. The processor may be a processor of a UE (such as a processor(s) 1404 of a wireless device 1402 that is a UE, as described herein). These instructions may be, for example, located in the processor and/or on a memory of the UE (such as a memory 1406 of a wireless device 1402 that is a UE, as described herein).

Embodiments contemplated herein include an apparatus comprising means to perform one or more elements of the method 1200. This apparatus may be, for example, an apparatus of a base station (such as a RAN device 1418 that is a base station, as described herein).

Embodiments contemplated herein include one or more non-transitory computer-readable media comprising instructions to cause an electronic device, upon execution of the instructions by one or more processors of the electronic device, to perform one or more elements of the method 1200. This non-transitory computer-readable media may be, for example, a memory of a base station (such as a memory 1422 of a RAN device 1418 that is a base station, as described herein).

Embodiments contemplated herein include an apparatus comprising logic, modules, or circuitry to perform one or more elements of the method 1200. This apparatus may be, for example, an apparatus of a base station (such as a RAN device 1418 that is a base station, as described herein).

Embodiments contemplated herein include an apparatus comprising: one or more processors and one or more computer-readable media comprising instructions that, when executed by the one or more processors, cause the one or more processors to perform one or more elements of the method 1200. This apparatus may be, for example, an apparatus of a base station (such as a RAN device 1418 that is a base station, as described herein).

Embodiments contemplated herein include a signal as described in or related to one or more elements of the method 1200.

Embodiments contemplated herein include a computer program or computer program product comprising instructions, wherein execution of the program by a processing element is to cause the processing element to carry out one or more elements of the method 1200. The processor may be a processor of a base station (such as a processor(s) 1420 of a RAN device 1418 that is a base station, as described herein). These instructions may be, for example, located in the processor and/or on a memory of the base station (such as a memory 1422 of a RAN device 1418 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
receiving, from a network, on a terrestrial network (TN) cell, system information (SI) comprising cell reselection configuration information for a non-terrestrial network (NTN) neighbor cell of the network, wherein the cell reselection configuration information for the NTN neighbor cell comprises a cell reselection condition for measuring the NTN neighbor cell;
determining that the cell reselection condition for measuring the NTN neighbor cell is fulfilled; and
measuring the NTN neighbor cell for purposes of a cell reselection in response to the determining that the cell reselection condition for measuring the NTN neighbor cell is fulfilled.

2. The method of claim 1, further comprising:
determining, based on the measuring of the NTN neighbor cell, that the NTN neighbor cell meets neighbor cell criteria for the cell reselection; and
performing the cell reselection to the neighbor cell.

3. The method of claim 1, wherein the cell reselection configuration information for the NTN neighbor cell further comprises an epoch time for the NTN neighbor cell.

4. The method of claim 1, wherein the cell reselection configuration information for the NTN neighbor cell further comprises a validity duration for the cell reselection configuration information.

5. The method of claim 1, wherein the cell reselection configuration information for the NTN neighbor cell indicates a frequency of the NTN neighbor cell.

6. The method of claim 1, wherein the cell reselection configuration information for the NTN neighbor cell further comprises a physical cell identifier (PCI) of the NTN neighbor cell.

7. The method of claim 1, wherein the cell reselection condition for measuring the NTN neighbor cell comprises that a radio quality of the TN cell is less than a threshold value.

8. The method of claim 7, wherein the cell reselection condition for measuring the NTN neighbor cell further comprises that the radio quality of the TN cell is less than the threshold value for a delay timer duration.

9. The method of claim 1, wherein the cell reselection condition for measuring the NTN neighbor cell comprises that the UE is located in a geographical area for using the NTN neighbor cell.

10. The method of claim 1, wherein the cell reselection condition for measuring the NTN neighbor cell comprises that there has been no available TN cell at a location of the UE for a TN search duration.

11. The method of claim 1, wherein the cell reselection condition for measuring the NTN neighbor cell comprises that there is no available preconfigured TN cell at a location of the UE.

12. The method of claim 1, wherein the cell reselection condition for measuring the NTN neighbor cell comprises that a first priority of the NTN neighbor cell is higher than a second priority of the TN cell.

13. The method of claim 1, wherein the SI comprising the cell reselection configuration information for the NTN neighbor cell is received in:
a system information block (SIB) 2, one of a SIB 3 and a SIB 4, and a SIB 19;
a SIB 2, one of a SIB 3 and a SIB 4, and a first SIB containing information that is relevant only for NTN neighbor cell reselection;
a SIB 2 and one of a SIB 3 and a SIB 4; or
only a second SIB containing information that is relevant for the NTN neighbor cell reselection.

14. A method of a radio access network (RAN), comprising sending, to a user equipment (UE), on a terrestrial network (TN) cell operated by the RAN, system information (SI) comprising cell reselection configuration information for a non-terrestrial network (NTN) neighbor cell of the UE that is operated by the RAN, wherein the cell reselection configuration information for the NTN neighbor cell comprises a cell reselection condition for measuring the NTN neighbor cell.

15. The method of claim 14, wherein the cell reselection configuration information for the NTN neighbor cell further comprises an epoch time for the NTN neighbor cell.

16. The method of claim 14, wherein the cell reselection configuration information for the NTN neighbor cell further comprises a validity duration for the cell reselection configuration information.

17. The method of claim 14, wherein the cell reselection configuration information for the NTN neighbor cell indicates a frequency of the NTN neighbor cell.

18. The method of claim 14, wherein the cell reselection configuration information for the NTN neighbor cell further comprises a physical cell identifier (PCI) of the NTN neighbor cell.

19. The method of claim 14, wherein the cell reselection condition for measuring the NTN neighbor cell comprises that a radio quality of the TN cell is less than a threshold value.

20. The method of claim 19, wherein the cell reselection condition for measuring the NTN neighbor cell further comprises that the radio quality of the TN cell is less than the threshold value for a delay timer duration.

21-28. (canceled)
